(19) United States
(12) Patent Application Publication
(10) Pub. No.: US 2014/0071273 A1
(43) Pub. Date: Mar. 13, 2014

(54) Recognition Based Security

(71) Applicants: Eddie Balthasar, Folsom, CA (US); Hong Li, El Dorado Hills, CA (US); Donald G. Meyers, Rescue, CA (US)

(72) Inventors: Eddie Balthasar, Folsom, CA (US); Hong Li, El Dorado Hills, CA (US); Donald G. Meyers, Rescue, CA (US)

(21) Appl. No.: 13/976,310

(22) PCT Filed: Mar. 30, 2012
(86) PCT No.: PCT/US2012/031686

§ 371 Date: Jun. 26, 2013

(51) Int. Cl. G08B 13/196

(52) U.S. Cl. CPC G08B 13/196
USPC 348/143

(57) ABSTRACT

Recognition-base security including use of an image capture device to capture images of a visiting individual. An image analysis agent coupled with the image capture device to receive a captured image, to compare characteristics of the captured image to stored characteristics of visitor profiles, to transmit an indication of a match between the captured image and one of the visitor profiles to a user associated with a building visited by the visiting individual. A security response agent coupled with the image analysis agent and the electronic system to generate a policy-determined response to the visiting individual based on the identity. The policy-determined response comprises providing a signaling response to the user and/or the visiting individual.

### TECHNICAL FIELD

Embodiments of the invention relate to, for example, building security systems. More particularly, embodiments of the invention relate to techniques for facial recognition that may be utilized with security systems.

### BACKGROUND

Current building (e.g., home, office) security systems may utilize a camera or other imaging device to provide live video feeds or images to a recording or display device, for example, a DVD recorder, a video display or mobile device. This may allow a person to see who or what is in view of the camera or imaging device. Some systems further include an intercom or other audio communications mechanism that may allow two-way communication. However, these systems cannot use the information being captured to make independent decisions on behalf of the user or follow instructions provided by the user.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a recognition-based security system.

FIG. 2 is a block diagram of one embodiment of an electronic system.

FIG. 3 is a flow diagram of one embodiment of operation of a recognition-based security system.

FIG. 4 is a block diagram of one embodiment of an image analysis agent.

FIG. 5 is a block diagram of one embodiment of a security response agent.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

The techniques described herein provide a level of intelligence to security systems by utilizing, for example, facial recognition capabilities, and possibly logo or insignia recognition capabilities and even recorded voice patterns for voice recognition, to determine the identity of an individual by comparing collected meta information provided by the user or information derived by viewing and scanning information collected from, for example, social networking or cloud services resources.

These techniques may provide additional information regarding a person at or near an entrance, which may enable a more customized and knowledgeable response. These techniques may also provide the ability to implement individual and group policies and/or automated responses depending on the monitored conditions. For example, two-way communications may be selectively provided between a resident and a visitor even when the resident is not on the premises.

Additional information and/or responses may be correlated to individual visits by frequency, time of day and/or utilizing stored historical information to identify visiting patterns that could be used, for example, by enforcement or legal agencies to support complaints or concerns or identify risks. Other applications may also be provided.

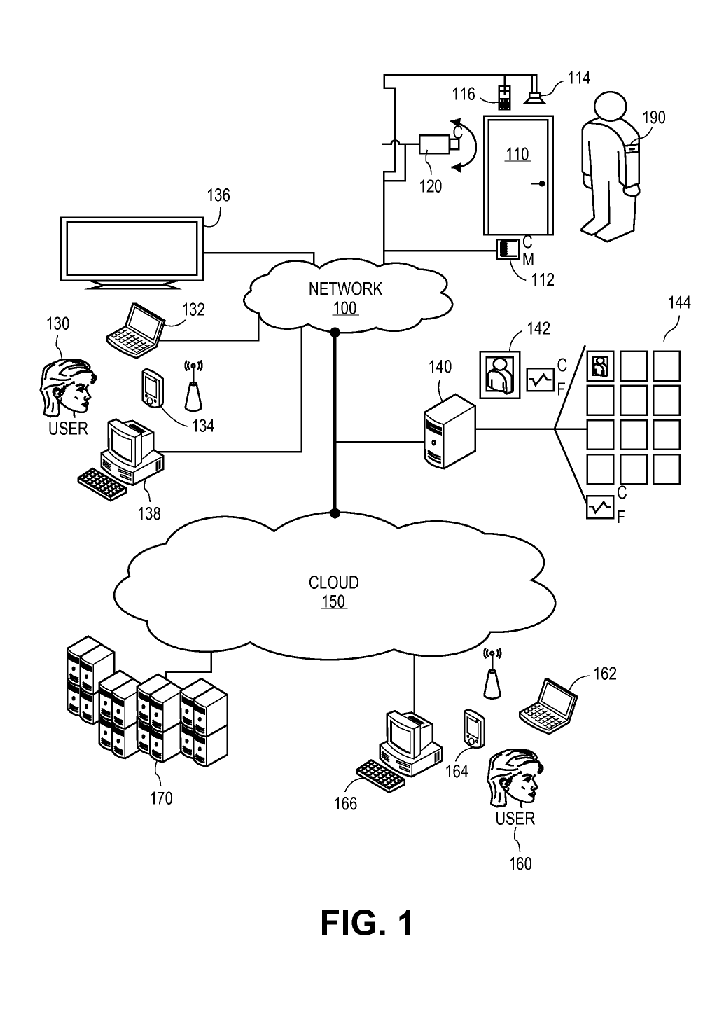

FIG. 1 is a block diagram of one embodiment of a recognition-based security system. The example of FIG. 1 is directed to a residential application; however, the techniques described herein are applicable to other settings.

The example of FIG. 1 may utilize network 100 to interconnect multiple components of the recognition-based security system. Network 100 may be any combination of wired and wireless components that provide network connectivity.

As visitor 190 approaches door 110, one or more components may be utilized to detect the presence of visitor 190. Motion sensor 114, camera 120, intercom/keypad 116 and/or doorbell 112 may operate to detect visitor 190. In one embodiment, camera 120 may be triggered by motion detection or other detection mechanisms to stream captured video information to one or more destinations via network 100.

Information gathered from camera 120 and/or other components surrounding door 110 may be transmitted to one or more electronic systems accessible to user 130. These may include, for example, video monitor 136, mobile computing device 132, smartphone/tablet 134, and/or computer system 138.

One or more of these electronic systems (e.g., 132, 134, 136, 138) may utilize visual recognition capabilities to capture images and/or logos or other information to be analyzed along with stored information to provide information to user 130. The one or more electronic systems operate to analyze the visual information (and may also utilize audio information) to search for a match of a known visitor or individual.

In one embodiment server 140 may include meta data gathered for multiple visitors 144 and may store this information for indentifying visitor 190. In one embodiment, information gathered from various sources (e.g., 114, 120, 116) may be compiled to visitor profile 142 that may be transmitted to server 140 or generated by server 140.

Visitor profile 142 may be compared to stored visitor information and/or profiles 144 maintained by server 140. An indication of whether a match is found and information related to visitor 190 may then be provided to one or more devices (e.g., 132, 134, 136, 138) associated with user 130.

In one embodiment, if visitor profile 142 is not recognized locally (e.g., by server 140), a further search may be initiated utilizing, for example, a social network corresponding to user 130, or other network resources. These remote resources 170 may be accessed via cloud 150 (e.g., the internet) and may be distributed across multiple physical locations.

During the search process, the system may provide to visitor 190 an audible indication requesting visitor 190 to wait, or the system may provide some other pre-selected response. At any stage of the search process, the system may apply a policy for unknown visitors, which may be, for example, to request that visitor 190 leave a message without sending a notification to user 130. Other policies may also be implemented.

If visitor 190 is recognized, either from information on server 140, information from remote resources 170 or any combination thereof, a visitor policy may be applied based in the identity of visitor 190. The policy may be, for example, to request a response from visitor 190 without notifying user 130, notifying user 130 with an audible signal, providing user 130 with video information and providing user 130 with response options, etc. Other policies may also be implemented.

So far, notification has been provided to user 130 via one or more electronic systems. However, in some embodiments, information about visitor 190 may be provided to remote user 160 via one or more electronic systems, for example, mobile computing device 162, smartphone/tablet 164, and/or computer system 166. User 160 may be, for example, a resident of the location visited by visitor 190, or user 160 may be a security agent or other agent responsible for responding to visitor 190. User 160 may also be the same as user 130, i.e., when there is nobody home, the notification can still be sent to the home owner away from home if policies are set that way.

In one embodiment, user 130 and/or user 160 may be notified by, for example, an audible tone, an audible or visual message or signal, etc. These notifications may be based on policies and an identity of visitor 190. Other factors may also be included in the policy, for example, time of day, day of the week, weather, visitor patterns, expected visitors, calendar events, etc. The user may then respond to the notification using one of the devices or by going to door 110.

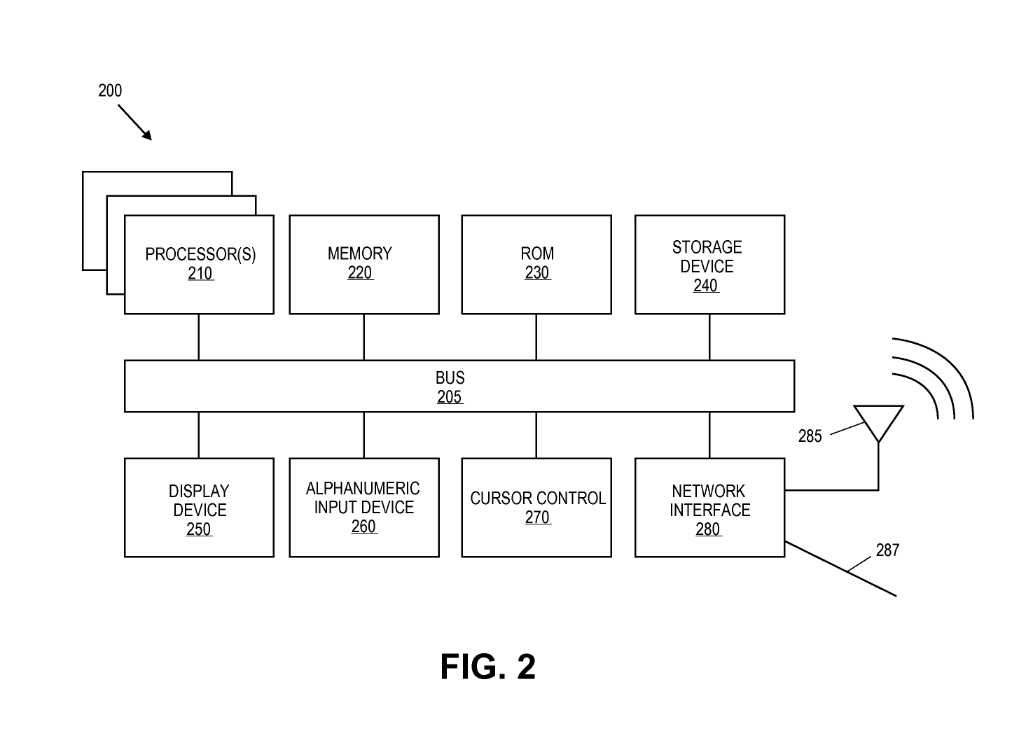

FIG. 2 is a block diagram of one embodiment of an electronic system. The electronic system illustrated in FIG. 2 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components. The electronic system of FIG. 2 may represent any of the electronic systems of FIG. 1.

Electronic system 200 includes bus 205 or other communication device to communicate information, and processor 210 coupled to bus 205 that may process information. While electronic system 200 is illustrated with a single processor, electronic system 200 may include multiple processors and/or co-processors. Electronic system 200 further may include random access memory (RAM) or other dynamic storage device 220 (referred to as main memory), coupled to bus 205 and may store information and instructions that may be executed by processor 210. Main memory 220 may also be used to store temporary variables or other intermediate information during execution of instructions by processor 210.

Electronic system 200 may also include read only memory (ROM) and/or other static storage device 230 coupled to bus 205 that may store static information and instructions for processor 210. Data storage device 240 may be coupled to bus 205 to store information and instructions. Data storage device 240 such as a magnetic disk, optical disc, solid state disk, or a remote storage service in the cloud, and corresponding drive may be coupled to electronic system 200.

Electronic system 200 may also be coupled via bus 205 to display device 250, such as a cathode ray tube (CRT) or liquid crystal display (LCD), to display information to a user. Alphanumeric input device 260, including alphanumeric and other keys, may be coupled to bus 205 to communicate information and command selections to processor 210. Another type of user input device is cursor control 270, such as a mouse, a trackball, or cursor direction keys to communicate direction information and command selections to processor 210 and to control cursor movement on display 250.

Electronic system 200 further may include network interface(s) 280 to provide access to a network, such as a local area network. Network interface(s) 280 may include, for example, a wireless network interface having antenna 285, which may represent one or more antenna(e). Network interface(s) 280 may also include, for example, a wired network interface to communicate with remote devices via network cable 287, which may be, for example, an Ethernet cable, a coaxial cable, a fiber optic cable, a serial cable, or a parallel cable.

In one embodiment, network interface(s) 280 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces such as 4G wireless network and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 280 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

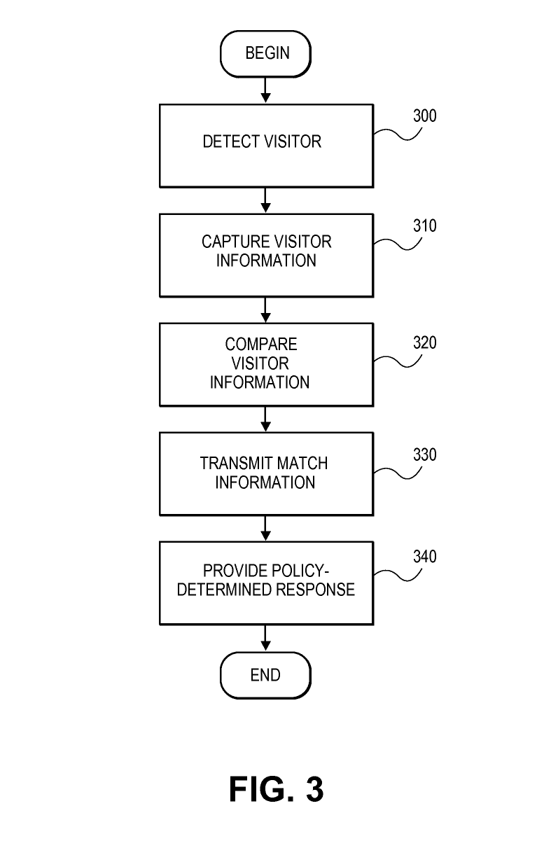

FIG. 3 is a flow diagram of one embodiment of operation of a recognition-based security system. The operation described with respect to FIG. 3 may be utilized with the system of FIG. 1, for example.

A visitor is detected, 300. The presence of the visitor can be detected by one or more mechanisms including, but not limited to, motion sensors, doorbells, microphones, cameras, keypads, pressure sensors, radar, sonar, etc. In one embodiment, the mechanisms that detect the presence of the visitor are utilized, either directly or indirectly, to control one or more audio and/or video capture devices.

Visitor information is captured, 310. In one embodiment, one or more images of the visitor are captured by a video camera or other image capture device. In another embodiment, audio information may be captured. Both audio and video information may be captured. The information captured by the camera, microphones and/or other devices may be utilized to determine an identity of the visitor.

In one embodiment, the captured information may be filtered so that certain aspects are extracted. For example, images may be processed so that facial images may be used for identification purposes. Also, clothing and or logos may be isolated and used for identification purposes, or voice recognition capabilities may be employed. The filtering may be performed by any component of the security system, for example, the system illustrated in FIG. 1.

The captured and/or filtered visitor information is compared to stored visitor information, 320, to determine if there is a match. The stored visitor information may be information gathered from previous visitors or visits. The stored visitor information may include, for example, facial information, visit history, reasons for visits, etc. Any relevant information may be utilized. The stored visitor information may be stored on one or more devices local to the security system, or the information may be available from remote sources, for example, remote databases, social networking resources, internet search engines, government resources.

If a match is found, match information is transmitted to a user, 330. For example, if the visitor is a neighbor and the system identifies the visitor as the neighbor, an indication of the match and the identity of the visitor may be transmitted. If no match is found, an indication of that result may be transmitted.

A policy-determined response is provided, 340. Policies may be based on classes of visitors, for example, unknown visitors may be asked to leave a message and the user/resident may not be notified, or expected visitors may be admitted and/or the user/resident may be notified. Deliveries may be accepted via audio instructions to the visitor. Many different policies and policy types may be supported.

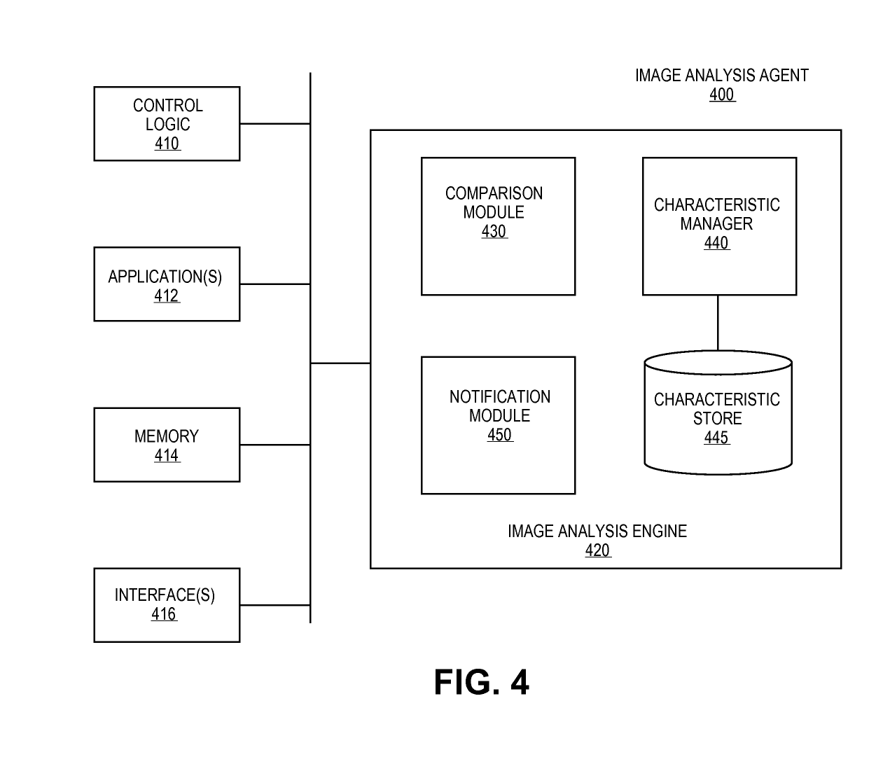

FIG. 4 is a block diagram of one embodiment of an image analysis agent. The image analysis agent that may be resident within, for example, a security application, an electronic system providing a security application, or a combination thereof. Image analysis agent 400 includes control logic 410, which implements logical functional control to direct operation of image analysis agent 400, and/or hardware associated with directing operation of image analysis agent 400. Logic may be hardware logic circuits and/or software routines. In one embodiment, image analysis agent 400 includes one or more applications 412, which represent code sequence and/or programs that provide instructions to control logic 410.

Image analysis agent 400 includes memory 414, which represents a memory device and/or access to a memory resource for storing data and/or instructions. Memory 414 may include memory local to image analysis agent 400, as well as, or alternatively, including memory of the host system on which image analysis agent 400 resides. Image analysis agent 400 also includes one or more interfaces 416, which represent access interfaces to/from (e.g., an input/output interface, application programming interface) image analysis agent 400 with regard to entities (electronic or human) external to image analysis agent 400.

Image analysis agent 400 also includes image analysis engine 420, which represents one or more functions that enable image analysis agent 400 to provide the functionality described herein. Example modules that may be included in image analysis engine 420 are comparison module 430, characteristic manager, 440 characteristic store 445 and notification module 450. Each of these modules may further include other modules to provide other functions. As used herein, a module refers to routine, a subsystem, etc., whether implemented in hardware, software, firmware or some combination thereof.

Comparison module 430 operates to compare captured information about the visitor with stored characteristics to determine if there is a match. Comparison module 430 may operate on one or more characteristics and may utilize a weighting scheme to assign different weights to different characteristics. The weights assigned may be constant or may be modifiable by comparison module 430 based on one or more conditions.

Characteristic manager 440 may operate with comparison manager 430 to provide stored characteristic information for comparison purposes. The example of FIG. 4 includes characteristic store 445, which represents locally stored characteristic information (whether within image analysis agent 400 or not); however, characteristic manager 440 may also provide access to remote characteristic information. For example, characteristic manager 440 may operate to utilize remote resources such as internet search engines to find useful information, or multimedia/image databases, whether local or remote, may be searched. Characteristic information may be any type of information that may help identify an individual, for example, facial recognition, visible badges or logos, as well as other characteristics listed herein as well as similar characteristics.

Notification module 450 may operate with comparison module 430 to provide a notification of the comparison result. For example, notification module 450 may provide a signal to another agent that may provide a policy-based response, or notification module 450 may indicate that no match has been found. The notification module may include reference information that may otherwise help identify the visitor if no affirmative match is found. Notification module 450 can provide other notification functionality as well.

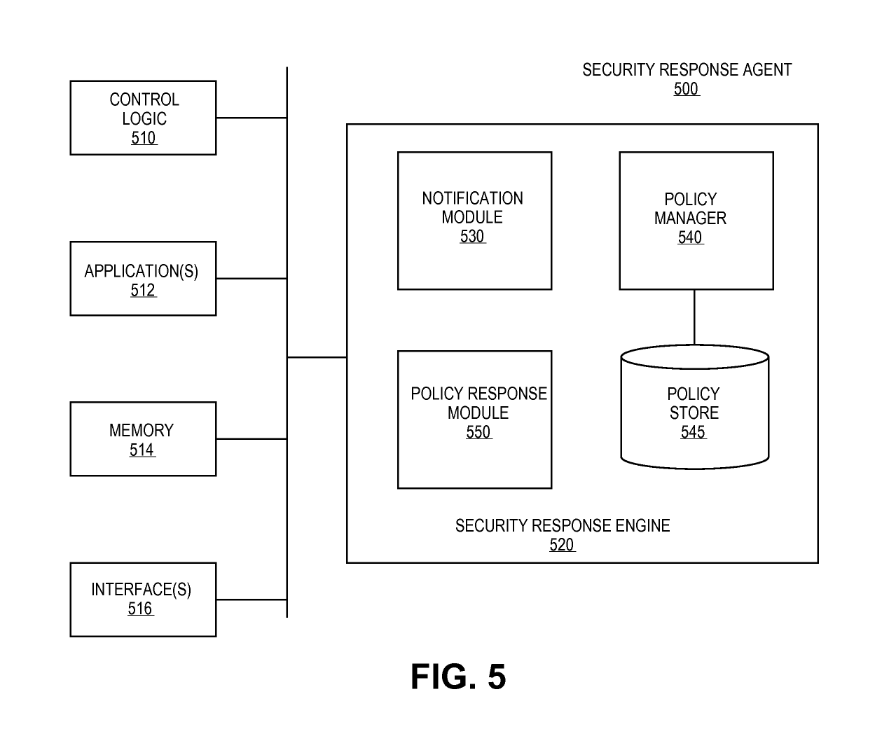

FIG. 5 is a block diagram of one embodiment of a security response agent. The security response agent that may be resident within, for example, a security application, an electronic system providing a security application, or a combination thereof. Security response agent 500 includes control logic 510, which implements logical functional control to direct operation of security response agent 500, and/or hardware associated with directing operation of security response agent 500. Logic may be hardware logic circuits and/or software routines. In one embodiment, security response agent 500 includes one or more applications 512, which represent code sequence and/or programs that provide instructions to control logic 510.

Security response agent 500 includes memory 514, which represents a memory device and/or access to a memory resource for storing data and/or instructions. Memory 514 may include memory local to security response agent 500, as well as, or alternatively, including memory of the host system on which security response agent 500 resides. Security response agent 500 also includes one or more interfaces 516, which represent access interfaces to/from (e.g., an input/output interface, application programming interface) security response agent 500 with regard to entities (electronic or human) external to security response agent 500.

Security response agent 500 also includes security response engine 520, which represents one or more functions that enable security response agent 500 to provide the functionality as described herein. Example modules that may be included in security response engine 520 are notification module 530, policy manager, 540 policy store 545 and policy response module 550. Each of these modules may further include other modules to provide other functions. As used herein, a module refers to routine, a subsystem, etc., whether implemented in hardware, software, firmware or some combination thereof.

Notification module 530 may operate to provide a notification of the comparison result, for example, a match as indicated by the image analysis agent of FIG. 4, or other mechanism. For example, notification module 530 may operate with policy manager 540 and policy response module 550 to provide a policy-based response. Notification module 530 can provide other notification functionality as well.

Policy manager 540 may operate with notification module 530 to provide stored policy information for response purposes. The example of FIG. 5 includes policy store 545, which represents locally stored policy information (whether within security response agent 500 or not); however, policy manager 530 may also provide access to remote policy information.

Policy response module 550 may operate to cause the selected policy-based response to be set in motion. For example, a pre-recorded or pre-selected response to the visitor and/or to a resident of the building, a notification to the police department, or a trigger to the home security alarm system. The responses to different parties may be selected based on a variety of factors pre-configured by the user.

Recognition-base security including use of an image capture device to capture images of a visiting individual. An image analysis agent coupled with the image capture device to receive a captured image, to compare characteristics of the captured image to stored characteristics of visitor profiles, to transmit an indication of a match between the captured image and one of the visitor profiles to a user associated with a building visited by the visiting individual. A security response agent coupled with the image analysis agent and the electronic system to generate a policy-determined response to the visiting individual based on the identity. The policy-determined response comprises providing a signaling response to the user and/or the visiting individual.

The one or more characteristics can include one or more of facial characteristics, visible logos, time of day, day of week, day of month, visitation patterns, weather conditions, clothing color, number of visitors, clothing style. The policy-determined response can include providing a pre-recorded audio message selected from a plurality of pre-recorded audio messages based on an identity of the visiting individual. The policy-determined response can include providing a pre-recorded audio message to a user, the pre-recorded audio message selected from a plurality of pre-recorded audio messages based on an identity of a visiting individual or auto-triggering home security alarm, auto-notify law enforcement or a remote user.

The image analysis agent may use stored characteristics gathered from the image capture device and from remote social network resources or internet search engine, cloud service providers. The policy-determined response can include providing a visual representation to the user indicating an identity of the visiting individual or relevant textual information that helps identify or rate the visitor will be provided. The image analysis agent may use stored characteristics gathered from the image capture device and from remote social network resources and/or internet search engine, government information, cloud service providers.

Various techniques may be used to provide recognition-based security, which may include utilization of non-transitory computer-readable media. The presence of a visiting individual at a building exterior location may be detected. At least one image of the visiting individual with an image capture device in response to detecting the presence of the visiting individual is captured. One or more characteristics of the captured image to stored characteristics of visitor profiles with an image analysis agent are compared. An indication of a match between the captured image and one of the visitor profiles is transmitted to an electronic system corresponding to a user. The user may be associated with a building visited by the visiting individual. A policy-determined response to the visiting individual is generated based on the identity. The policy-determined response comprises providing a signaling response to the user and/or the visiting individual.

The one or more characteristics can include one or more of facial characteristics, visible logos, time of day, day of week, day of month, visitation patterns, weather conditions, clothing color, number of visitors, clothing style. The policy-determined response can include providing a pre-recorded audio message selected from a plurality of pre-recorded audio messages based on an identity of the visiting individual. The policy-determined response can include providing a pre-recorded audio message to a user, the pre-recorded audio message selected from a plurality of pre-recorded audio messages based on an identity of a visiting individual or auto-triggering home security alarm, auto-notify law enforcement or a remote user.

The image analysis agent may use stored characteristics gathered from the image capture device and from remote social network resources or internet search engine, cloud service providers. The policy-determined response can include providing a visual representation to the user indicating an identity of the visiting individual or relevant textual information that helps identify or rate the visitor will be provided. The image analysis agent may use stored characteristics gathered from the image capture device and from remote social network resources and/or internet search engine, government information, cloud service providers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A system comprising:
an image capture device to capture images;
an image analysis agent coupled with the image capture device to receive at least one captured image, the image analysis agent to compare one or more characteristics of the captured image to stored characteristics of visitor profiles, the image analysis agent to transmit an indication of a match between the captured image and one of the visitor profiles to an electronic system corresponding to a building;
a security response agent coupled with the image analysis agent and the electronic system, the security response agent to generate a policy-determined response based on the identity, wherein the policy-determined response comprises providing a signaling response.

2. The system of claim 1 wherein the one or more characteristics comprise one or more of: facial characteristics, visible logos, time of day, day of week, day of month, visitation patterns, weather conditions, clothing color, number of visitors, clothing style.

3. The system of claim 1 wherein the policy-determined response comprises providing a pre-recorded audio message selected from a plurality of pre-recorded audio messages based on an identity of the visiting individual.

4. The system of claim 1 wherein the policy-determined response comprises providing a pre-recorded audio message to a user, the pre-recorded audio message selected from a plurality of pre-recorded audio messages based on an identity of a visiting individual or auto-triggering home security alarm, auto-notify law enforcement or a remote user.

5. The system of claim 1 wherein the image analysis agent utilizes stored characteristics gathered from the image capture device and from remote social network resources or internet search engine, cloud service providers.

6. The system of claim 1 wherein the policy-determined response comprises providing a visual representation to the user indicating an identity of the visiting individual or relevant textual information that helps identify or rate the visitor will be provided.

7. The system of claim 1 wherein the image analysis agent utilizes stored characteristics gathered from the image capture device and from remote social network resources and/or internet search engine, government information, cloud service providers.

8. A method comprising:
detecting a presence of a visiting individual at a building exterior locations;
capturing at least one image of the visiting individual with an image capture device in response to detecting the presence of the visiting individual;
comparing one or more characteristics of the captured image to stored characteristics of visitor profiles with an image analysis agent;
transmitting an indication of a match between the captured image and one of the visitor profiles to an electronic system corresponding to a user, the user being associated with a building visited by the visiting individual;
generating a policy-determined response to the visiting individual based on the identity, wherein the policy-determined response comprises providing a signaling response to the user and/or the visiting individual.

9. The method of claim 8 wherein the one or more characteristics comprise one or more of: facial characteristics, visible logos, time of day, day of week, day of month, visitation patterns, weather conditions, clothing color, number of visitors, clothing style.

10. The method of claim 8 wherein the policy-determined response comprises providing a pre-recorded audio message to the visiting individual, the pre-recorded audio message selected from a plurality of pre-recorded audio messages based on an identity of the visiting individual.

11. The method of claim 8 wherein the policy-determined response comprises providing a pre-recorded audio message to the user, the pre-recorded audio message selected from a plurality of pre-recorded audio messages based on an identity of the visiting individual or auto-triggering home security alarm, auto-notify law enforcement or a remote user.

12. The method of claim 8 wherein the image analysis agent utilizes stored characteristics gathered from the image capture device and from remote social network resources or internet search engine, government information, cloud service providers.

13. The method of claim 8 wherein the policy-determined response comprises providing a visual representation to the user indicating an identity of the visiting individual or relevant textual information that helps identify or rate the visitor will be provided.

14. The method of claim 8 wherein the image analysis agent utilizes stored characteristics gathered from the image capture device and from remote social network resources and/or internet search engine, cloud service providers.

15. A non-transitory computer-readable medium having stored thereon instructions that, when executed, cause one or more processors to:
detect a presence of a visiting individual at a building exterior locations;
capture at least one image of the visiting individual with an image capture device in response to detecting the presence of the visiting individual;
compare one or more characteristics of the captured image to stored characteristics of visitor profiles with an image analysis agent;
transmit an indication of a match between the captured image and one of the visitor profiles to an electronic system corresponding to a user, the user being associated with a building visited by the visiting individual;
generate a policy-determined response to the visiting individual based on the identity, wherein the policy-determined response comprises providing a signaling response to the user or the visiting individual.

16. The medium of claim 15 wherein the one or more characteristics comprise one or more of: facial characteristics, visible logos, time of day, day of week, day of month, visitation patterns, weather conditions, clothing color, number of visitors, clothing style.

17. The medium of claim 15 wherein the policy-determined response comprises providing a pre-recorded audio message to the visiting individual, the pre-recorded audio message selected from a plurality of pre-recorded audio messages based on an identity of the visiting individual.

18. The medium of claim 15 wherein the policy-determined response comprises providing a pre-recorded audio message to the user, the pre-recorded audio message selected from a plurality of pre-recorded audio messages based on an identity of the visiting individual or auto-triggering home security alarm, auto-notify law enforcement or a remote user.

19. The medium of claim 15 wherein the image analysis agent utilizes stored characteristics gathered from the image capture device and from remote social network resources and/or internet search engine, cloud service providers.

20. The medium of claim 15 wherein the policy-determined response comprises providing a visual representation to the user indicating an identity of the visiting individual or relevant textual information that helps identify or rate the visitor will be provided.

21. The medium of claim 15 wherein the image analysis agent utilizes stored characteristics gathered from the image capture device and from remote social network resources and/or internet search engine, government information, cloud service providers.
